(19) United States
(12) Patent Application Publication
(10) Pub. No.: US 2020/0007435 A1
(43) Pub. Date: Jan. 2, 2020

(54) METHODS, APPARATUSES AND COMPUTER-READABLE STORAGE MEDIUMS FOR DYNAMICALLY CONTROLLING TRAFFIC OVER PEERING LINKS

(71) Applicant: Nokia Solutions and Networks OY, Espoo (FI)

(72) Inventors: Rajesh Kumar Paida, Ontario (CA); Ebrahim Ghazisaeedi, Ottawa (CA); Ehsan Rezaaifar, Ontario (CA); Hamid Ould-Brahim, Ottawa (CA)

(73) Assignee: Nokia Solutions and Networks OY, Espoo (FI)

(21) Appl. No.: 16/019,799

(22) Filed: Jun. 27, 2018

(51) Int. Cl. H04L 12/707; H04L 12/801; H04L 12/813; H04L 12/815; H04L 12/751; H04L 12/26

(52) U.S. Cl. CPC H04L 45/22; H04L 47/11; H04L 43/0894; H04L 47/22; H04L 45/02; H04L 47/20

(57) ABSTRACT

A network controller detects a congested peering link between a first router and a second router, and selects a first group of traffic flows from among the plurality of traffic flows to be offloaded from the congested peering link. The congested peering link carries a plurality of traffic flows, and the first group of traffic flows is associated with a first steering entity indicative of destination information for the first group of traffic flows. The network controller then selects an alternate peering link between the first and second routers to which to offload the first group of traffic flows from the congested peering link, and steers the first group of traffic flows from the congested peering link to the alternate peering link.

### TECHNICAL FIELD

One or more example embodiments relate to methods, apparatuses and/or computer-readable storage mediums for dynamically controlling traffic over peering links in a network.

### BACKGROUND

The Border Gateway Protocol (BGP) is an inter-Autonomous System routing protocol defined in RFC 4271. In the related art, balancing utilization of links between BGP external peers (sometimes referred to as BGP external peering links) for incoming traffic is achieved by monitoring the BGP external peering link utilizations and traffic flows using third-party tools, and then manually deploying BGP policies on the routers by trial and error.

### SUMMARY

One or more example embodiments relate to methods, apparatuses and non-transitory computer-readable storage mediums for controlling routing decisions to more efficiently balance utilization on peering links (e.g., Border Gateway Protocol (BGP) peering links such as internal or external BGP peering links) for incoming (e.g., downlink) traffic. To this end, in at least one example embodiment, a network controller may utilize Software Defined Networking (SDN) to control routing decisions by combining data analytics and software control.

At least one example embodiment provides a network controller for steering traffic between peering links connecting autonomous systems within a network. The network controller comprises at least one processor and at least one memory including computer program code. The at least one memory and the computer program code are configured to, with the at least one processor, cause the network controller to: detect a congested peering link between a first autonomous system and a second autonomous system, the congested peering link carrying a plurality of traffic flows; select a first group of traffic flows from among the plurality of traffic flows to be offloaded from the congested peering link, the first group of traffic flows being associated with a first steering entity indicative of destination information for the first group of traffic flows; select an alternate peering link to which to offload the first group of traffic flows from the congested peering link, the alternate peering link being between the first autonomous system and the second autonomous system; and steer the first group of traffic flows from the congested peering link to the alternate peering link.

According to at least some example embodiments, the congested peering link and the alternate peering link may be external Border Gateway Protocol (E-BGP) peering links.

The at least one memory and the computer program code may be further configured to, with the at least one processor, cause the network controller to steer the first group of traffic flows by updating at least one BGP policy entry at least one border router within at least one of the first autonomous system or the second autonomous system.

The at least one memory and the computer program code may be further configured to, with the at least one processor, cause the network controller to steer the first group of traffic flows by: withdrawing routes for traffic flows including the congested peering link; and advertising routes for traffic flows including the alternate peering link.

The second autonomous system may be connected to a customer autonomous system including at least one customer experiencing congestion resulting from the congested peering link. The at least one memory and the computer program code may be further configured to, with the at least one processor, cause the network controller to steer the first group of traffic flows by: identifying, in the second autonomous system, at least one provider edge router connected to the customer experiencing the congestion; and deploying at least one BGP policy entry to the at least one provider edge router.

The at least one memory and the computer program code may be further configured to, with the at least one processor, cause the network controller to: identify slices within the second autonomous system configured to serve the customer experiencing the congestion based on topology information for the network; identify transit providers configured to serve the customer experiencing the congestion based on the topology information for the network; and generate the at least one BGP policy entry based on the slices, the transit providers and network configuration information for the network.

The first steering entity may include (i) a destination autonomous system for the first group of traffic flows, (ii) a destination subnetwork for the first group of traffic flows, or (iii) a BGP Community group for the first group of traffic flows.

The plurality of traffic flows may include a plurality of groups of traffic flows, each of the plurality of groups of traffic flows being associated with a steering entity.

The at least one memory and the computer program code may be further configured to, with the at least one processor, cause the network controller to: obtain aggregate data rates for each of the plurality of groups of traffic flows; sort the plurality of groups of traffic flows in descending order based on the aggregate data rates for the plurality of groups of traffic flows; and select a group of traffic flows having a highest aggregate data rate as the first group of traffic flows.

The alternate peering link may be a peering link connecting the first autonomous system and the second autonomous system, and an amount of available bandwidth on the alternate peering link may be such that addition of the first group of traffic flows from the congested peering link does not increase a link utilization of the alternate peering link above a steering threshold.

The at least one memory and the computer program code may be further configured to, with the at least one processor, cause the network controller to: determine that congestion on the congested peering link is not resolved in response to steering the first group of traffic flows from the congested peering link to the alternate peering link; select a second group of traffic flows from among the plurality of traffic flows to be offloaded from the congested peering link, the second group of traffic flows being associated with a second steering entity indicative of destination information for the second group of traffic flows; select a second alternate peering link to which to offload the second group of traffic flows from the congested peering link, the second alternate peering link being between the first autonomous system and the second autonomous system; and steer the second group of traffic flows from the congested peering link to the second alternate peering link.

At least one other example embodiment provides a network controller for steering traffic between peering links in a network. The network controller includes at least one processor and at least one memory including computer program code. The at least one memory and the computer program code are configured to, with the at least one processor, cause the network controller to: detect a congested peering link between a first router and a second router, the congested peering link carrying a plurality of traffic flows; select a first group of traffic flows from among the plurality of traffic flows to be offloaded from the congested peering link, the first group of traffic flows being associated with a first steering entity indicative of destination information for the first group of traffic flows; select an alternate peering link to which to offload the first group of traffic flows from the congested peering link, the alternate peering link being between the first router and the second router; and steer the first group of traffic flows from the congested peering link to the alternate peering link.

At least one other example embodiment provides a network controller for steering traffic between peering links in a network, the network controller comprising: means for detecting a congested peering link between a first router and a second router, the congested peering link carrying a plurality of traffic flows; means for selecting a first group of traffic flows from among the plurality of traffic flows to be offloaded from the congested peering link, the first group of traffic flows being associated with a first steering entity indicative of destination information for the first group of traffic flows; means for selecting an alternate peering link to which to offload the first group of traffic flows from the congested peering link, the alternate peering link being between the first router and the second router; and means for steering the first group of traffic flows from the congested peering link to the alternate peering link.

According to at least some example embodiments, the first router may be a border router in a first autonomous system and the second router may be a neighbor router in a second autonomous system.

The first router and the second router may have a border gateway protocol peering relationship.

The border gateway protocol peering relationship may be an internal Border Gateway Protocol (I-BGP) peering relationship or an external Border Gateway Protocol (E-BGP) peering relationship.

The at least one memory and the computer program code may be further configured to, with the at least one processor, cause the network controller to steer the first group of traffic flows by updating at least one border gateway protocol policy entry at one or more of the first router or the second router.

The memory and the computer program code may be further configured to, with the at least one processor, cause the network controller to steer the first group of traffic flows through border gateway protocol route distribution.

According to at least some example embodiments, the first router may be a border router in a first autonomous system, which is connected to a second autonomous system including at least one customer experiencing congestion resulting from the congested peering link. The at least one memory and the computer program code may be further configured to, with the at least one processor, cause the network controller to steer the first group of traffic flows by: identifying, in the first autonomous system, at least one provider edge router connected to the customer experiencing the congestion; and deploying at least one Border Gateway Protocol policy entry to the at least one provider edge router. The at least one memory and the computer program code may be further configured to, with the at least one processor, cause the network controller to: identify slices within the first autonomous system configured to serve the customer experiencing the congestion based on topology information for the network; identify transit providers configured to serve the customer experiencing the congestion based on the topology information for the network; and generate the at least one Border Gateway Protocol policy entry based on the slices, the transit providers and network configuration information for the network.

The memory and the computer program code may be further configured to, with the at least one processor, cause the network controller to detect the congested peering link based on a real-time link utilization threshold and a real-time link utilization for the congested peering link.

The at least one memory and the computer program code may be further configured to, with the at least one processor, cause the network controller to steer the first group of traffic flows by: withdrawing routes for traffic flows including the congested peering link; and advertising routes for traffic flows including the alternate peering link.

The first steering entity may include (i) a destination autonomous system for the first group of traffic flows, (ii) a destination subnetwork for the first group of traffic flows, or (iii) a Border Gateway Protocol Community group for the first group of traffic flows.

The plurality of traffic flows may include a plurality of groups of traffic flows, each of the plurality of groups of traffic flows being associated with a steering entity. The at least one memory and the computer program code may be further configured to, with the at least one processor, cause the network controller to: obtain aggregate data rates for each of the plurality of groups of traffic flows; and select a group of traffic flows having a highest aggregate data rate as the first group of traffic flows.

The at least one memory and the computer program code may be further configured to, with the at least one processor, cause the network controller to: determine that a total amount of traffic offloaded from the congested peering link by steering the first group of traffic flows from the congested peering link to the alternate peering link is less than a threshold data rate to be offloaded from the congested peering link; select a second group of traffic flows from among the plurality of traffic flows to be offloaded from the congested peering link, the second group of traffic flows being associated with a second steering entity indicative of destination information for the second group of traffic flows; select a second alternate peering link to which to offload the second group of traffic flows from the congested peering link, the second alternate peering link being between the first router and the second router; and steer the second group of traffic flows from the congested peering link to the second alternate peering link.

At least one other example embodiment provides a method for steering traffic between peering links in a network, the method comprising: detecting a congested peering link between a first router and a second router, the congested peering link carrying a plurality of traffic flows; selecting a first group of traffic flows from among the plurality of traffic flows to be offloaded from the congested peering link, the first group of traffic flows being associated with a first steering entity indicative of destination information for the first group of traffic flows; selecting an alternate peering link to which to offload the first group of traffic flows from the congested peering link, the alternate peering link being between the first router and the second router; and steering the first group of traffic flows from the congested peering link to the alternate peering link.

The first router and the second router may have a Border Gateway Protocol peering relationship. The Border Gateway Protocol peering relationship may be an internal Border Gateway Protocol (I-BGP) peering relationship or an external Border Gateway Protocol (E-BGP) peering relationship. The first router may be a border router in a first autonomous system and the second router may be a neighbor router in a second autonomous system.

The detecting may detect the congested peering link based on a real-time link utilization threshold and a real-time link utilization for the congested peering link.

At least one other example embodiment provides a non-transitory computer-readable medium including computer-readable instructions that, when executed, cause at least one processor at a network controller to cause the network controller to perform a method comprising: detecting a congested peering link between a first router and a second router, the congested peering link carrying a plurality of traffic flows; selecting a first group of traffic flows from among the plurality of traffic flows to be offloaded from the congested peering link, the first group of traffic flows being associated with a first steering entity indicative of destination information for the first group of traffic flows; selecting an alternate peering link to which to offload the first group of traffic flows from the congested peering link, the alternate peering link being between the first router and the second router; and steering the first group of traffic flows from the congested peering link to the alternate peering link.

The first router and the second router may have a Border Gateway Protocol peering relationship.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram illustrating an example of a network model in which example embodiments may be implemented;

FIG. 2 is a flow chart illustrating a method according to an example embodiment;

FIG. 3 is a flow chart illustrating another method according to an example embodiment;

FIG. 4 is a flow chart illustrating another method according to an example embodiment; and

FIG. 5 provides a general architecture and functionality suitable for implementing functional elements, or portions of functional elements, described herein.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

Accordingly, it should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Having substantially fair utilization (e.g., less than about 80%) of all (or substantially all) links between peers (e.g., Border Gateway Protocol (BGP) peers, such as internal or external BGP peers) over which inbound (e.g., downlink) traffic enters a network such as an Autonomous System (e.g., inter-Autonomous System traffic flows), and load balancing the links to reduce and/or minimize the utilization variance among the links, may be relatively important from a network perspective since the incoming traffic data rates are much higher in magnitude than outgoing traffic data rates. Load balancing of BGP external peering links may be achieved manually (e.g., by a network operator), but this method becomes relatively complex to manage when the number of BGP external peers becomes relatively large.

One or more example embodiments provide mechanisms to incrementally balance network utilization by configuring a network such that traffic (e.g., downlink traffic, such as inter-Autonomous System traffic, BGP Community traffic, IP Prefix traffic, or the like) may be steered to a specific transit provider, slice of an Autonomous System or link therebetween.

In at least one example embodiment, utilization of links between peers (e.g., BGP peers including internal and/or external BGP peers) may be automatically balanced more efficiently. The mechanisms to do so may utilize or be based on network statistics and/or the BGP protocol (e.g., including BGP protocol attributes such as Community, Autonomous System (AS)_Path and Multi Exit Discriminator (MED), or the like.

Although discussed herein with regard to downlink IP traffic (and IP traffic flows) destined for a customer Autonomous System (customer network), example embodiments may also be applicable to uplink traffic. Additionally, although discussed with regard to BGP, example embodiments should not be limited to this example. Further, although example embodiments are discussed herein primarily with regard to external BGP (E-BGP) peers and links (also sometimes referred to as E-BGP peerings or E-BGP peering links), it should be understood that example embodiments may be equally applicable to internal BGP (I-BGP) peers and links.

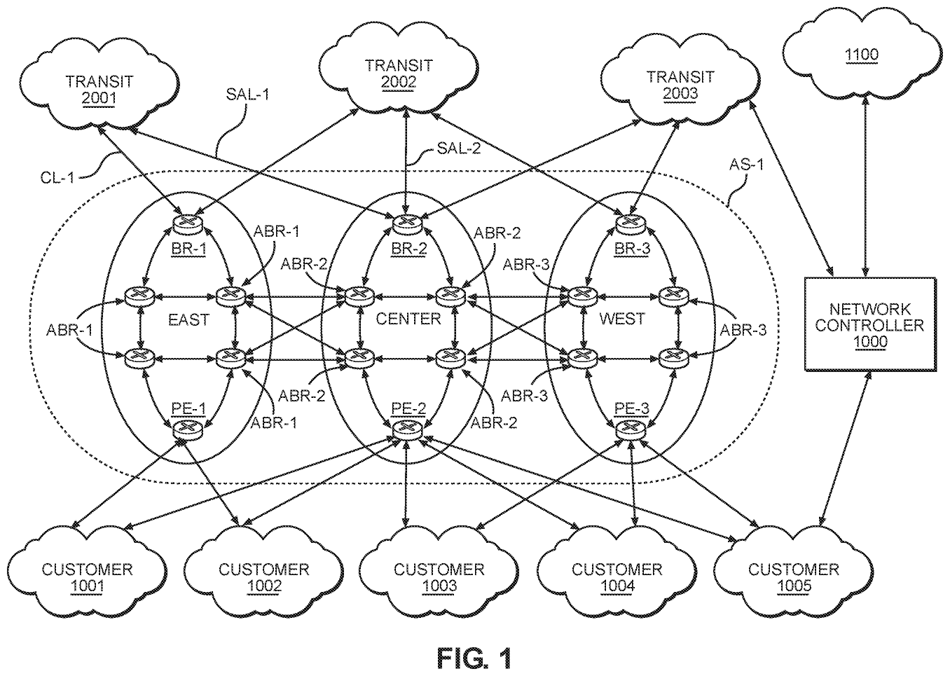

FIG. 1 illustrates an example network model in which example embodiments may be implemented. Example embodiments will be discussed herein with regard to the network model shown in FIG. 1. However, example embodiments should not be limited to only the example discussed herein.

Referring to FIG. 1, the network includes an Autonomous System AS-1, which is divided into three slices EAST, CENTER and WEST. A physical network topology may be divided into slices based on physical presence or business reasons. External traffic entering a slice may exit from the same slice or may transit through neighboring slices if (e.g., only if) connectivity to the destination is not directly available. Inter-slice transit links may be configured to have higher Interior Gateway Protocol (IGP) costs than intra-slice links.

The Autonomous System AS-1 is in communication with a plurality of transit providers 2001, 2002 and 2003 and a plurality of customer networks 1001, 1002, 1003, 1004 and 1005. The transit providers 2001, 2002 and 2003 are Autonomous Systems that provide access to the Internet. Customer networks 1001-1005 are Autonomous systems through which customers access the Autonomous System AS-1, the transit providers 2001-2003 and the Internet. Although FIG. 1 illustrates only a certain number of transit providers, Autonomous Systems, customer networks, etc., example embodiments should not be limited to this example. Rather, example embodiments may be applicable to a network including any number of elements.

The slice EAST includes an Autonomous System Border Router BR-1, a plurality of internal routers ABR-1, and a provider edge (PE) router PE-1. The Autonomous System Border Router BR-1 has external BGP (E-BGP) connections or links (also referred to herein as E-BGP, E-BGP peerings or E-BGP relationships) with the transit providers 2001 and 2002. The PE router PE-1 has E-BGP peerings with the customer networks 1001 and 1002. The plurality of internal routers ABR-1 route inbound and outbound traffic within the slice EAST as well as between the slices EAST and CENTER within the Autonomous System AS-1. In one example, the plurality of internal routers ABR-1 may be intra-Autonomous System routers, such as Area Border Routers.

The slice CENTER includes an Autonomous System Border Router BR-2, a plurality of internal routers ABR-2, and a PE router PE-2. The Autonomous System Border Router BR-2 has E-BGP peerings with transit providers 2001, 2002 and 2003. The PE router PE-2 has E-BGP peerings with customer networks 1001, 1002, 1003, 1004 and 1005. The plurality of internal routers ABR-2 route inbound and outbound traffic between areas within the slice CENTER as well as between the slices EAST, CENTER and WEST within the Autonomous System AS-1. In one example, the plurality of internal routers ABR-2 may be intra-Autonomous System routers, such as Area Border Routers.

The slice WEST includes an Autonomous System Border Router BR-3, a plurality of internal routers ABR-3, and a PE router PE-3. The Autonomous System Border Router BR-3 has E-BGP peerings with transit providers 2002 and 2003. The PE router PE-3 has E-BGP peerings with customer networks 1003, 1004 and 1005. As with slices EAST and CENTER, the plurality of internal routers ABR-3 route inbound and outbound traffic between areas within the slice WEST as well as between the slices WEST and CENTER within the Autonomous System AS-1. In one example, the plurality of internal routers ABR-3 may be intra-Autonomous System routers, such as Area Border Routers.

As mentioned above, the network includes customer networks 1001-1005. In the example embodiment shown in FIG. 1, the customer networks 1001-1005 have E-BGP peerings with the PE routers in different slices of the Autonomous System AS-1 for redundancy and to obtain network services. For example, each of customer networks 1001 and 1002 have an E-BGP peering with PE routers PE-1 and PE-2. Similarly, each of customer networks 1003, 1004 and 1005 have an E-BGP peering with PE routers PE-2 and PE-3

The Autonomous System Border Routers BR-1, BR-2 and BR-3 have overlapping E-BGP peerings with transit providers for redundancy. For example, the Autonomous System Border Router BR-1 has E-BGP peerings with transit providers 2001 and 2002, the Autonomous System Border Router BR-2 has E-BGP peerings with transit providers 2001, 2002 and 2003, and the Autonomous System Border Router BR-3 has E-BGP peerings with transit providers 2002 and 2003.

The Autonomous System Border Routers BR-1, BR-2, BR-3, the plurality of internal routers ABR-1, ABR-2, ABR-3 and the PE routers PE-1, PE-2, PE-3 have I-BGP relationships with one another. In one example, the routers have full I-BGP mesh to exchange external route information between one another. In one example with regard to I-BGP mesh, BGP routes for customers in a customer network may be received by PE routers on the local network (e.g., within the Autonomous System AS-1) through E-BGP peering links. The PE routers use their import policies on the BGP peering links to modify the received BGP routes and then advertise the modified routes to the border routers through I-BGP in the local network. The border routers then use export policies to further modify the routes, and propagate the modified routes to the transit providers.

In the network model shown in FIG. 1, it is assumed that the Interior Gateway Protocol (IGP) link costs between respective slices EAST, CENTER and WEST are higher (e.g., substantially higher) than the link costs within a respective slice to ensure that the traffic flows entering a respective slice always exit from the same respective slice.

Still referring to FIG. 1, a network controller 1000 is in two-way communication with each of the transit providers 2001, 2002 and 2003, each of the customer networks 1001-1005, and each of the network elements (e.g., the Autonomous System Border Routers BR-1, BR-2, BR-3, the internal routers ABR-1, ABR-2, ABR-3, and the PE routers PE-1, PE-2, PE-3) in the slices EAST, CENTER and WEST in the Autonomous System AS-1. The network controller 1000 is also in two-way communication with the cloud 1100.

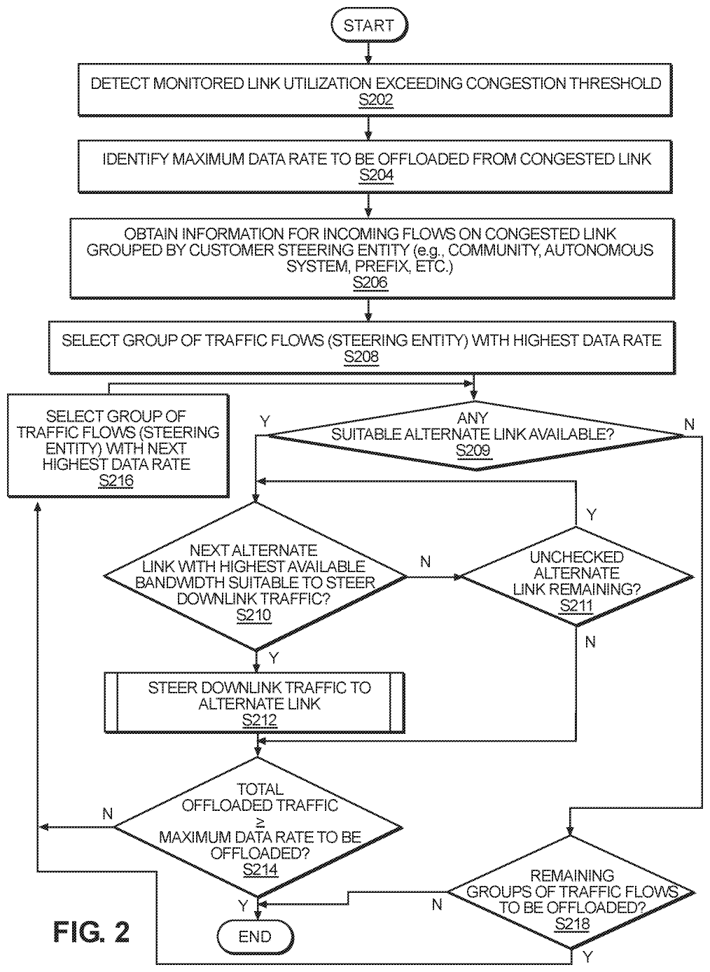

In one example, the cloud 1100 may include big data analytics with which the network controller 1000 is in communication and able to obtain data and information regarding the network. In the example embodiment shown in FIG. 1, the network controller 1000 has a topological graph view of the complete network, and may communicate with the network and network elements using various networking and Software Defined Networking (SDN) protocols. Example operation of the network controller 1000 in accordance with example embodiments will be discussed in more detail later with regard to FIGS. 2-4.

The network controller 1000 monitors (e.g., continuously monitors) all E-BGP peering links between transit providers 2001-2003 and Autonomous System Border Routers BR-1, BR-2, BR-3 for link utilization and IP traffic flows. In some cases, the network controller 1000 monitors these links continuously based on information provided by big data analytics in the cloud 1100. As discussed herein, these E-BGP peering links are sometimes referred to as monitored links or monitored peering links. Link utilization may be obtained by polling the data (e.g., from the cloud 1100) using, for example, Simple Network Management Protocol (SNMP), NETCONF, by using Telemetry streaming, or the like. IP traffic flows may be obtained by enabling packet sampling protocols such as, for example, CFLOWD, NETFLOW, or the like.

According to one or more example embodiments, when congestion is detected on a monitored link, the network controller 1000 performs traffic steering automatically by moving (or, alternatively, shifting or directing) one or more groups of IP traffic flows from the congested link (congested peering link) to one or more suitable alternate links (alternate peering links). The IP traffic flows on the congested link may be divided into groups according to destination information for the IP traffic flows. The destination information may include one or more steering entities, such as a destination Autonomous System (e.g., a customer network), destination subnetwork (e.g., network prefix), BGP Community group, or the like, for the IP traffic flows. For example purposes, example embodiments may be discussed herein with regard to traffic steering based on a destination Autonomous System, and more specifically, a destination customer network. In this example, the IP traffic flows may be divided into a plurality of groups of IP traffic flows, wherein each group of IP traffic flows may be associated with a steering entity (e.g., a destination customer network) among a set (plurality of) steering entities (e.g., a set or plurality of destination customer networks).

According to at least one example embodiment, when the network controller 1000 determines that utilization (e.g., a real-time link utilization) of a monitored link reaches (or exceeds) a given (or, alternatively, desired or predefined) real-time link utilization threshold (also referred to herein as a congestion threshold), the network controller 1000 automatically steers traffic from the congested link to one or more suitable alternate links (if available) to reduce the utilization of the congested link (e.g., to alleviate the congestion) and balance traffic in the network. In one example, the congestion threshold may be greater than or equal to about 80% utilization. In one example, if the threshold is a real-time link utilization threshold, this threshold may be defined by a network operator as desired, and need not necessarily correlate specifically to congestion in the network.

FIG. 2 is a flow chart illustrating a method according to an example embodiment. The method shown in FIG. 2 may be performed at the network controller 1000 to balance traffic in the network and alleviate congestion on the congested link.

Although FIG. 2 is described with regard to E-BGP relationships and peerings, it should be understood that example embodiments may be equally applicable to I-BGP relationships and peerings.

Referring to FIG. 2, at step S202 the network controller 1000 detects utilization of a monitored link exceeding a congestion threshold. In one example, the congestion threshold may be about 80% utilization of the link. As discussed above, the network controller 1000 may obtain and monitor link utilization by polling the data (e.g., in the cloud 1100) using, for example, Simple Network Management Protocol (SNMP), NETCONF, by using Telemetry streaming, or the like.

At step S204, the network controller 1000 identifies a (e.g., maximum) data rate to be offloaded from the congested link. The data rate to be offloaded may be determined based on a threshold parameter (e.g., an optimal threshold parameter), the current data rate on the congested link and the link capacity for the congested link. In one example, the threshold parameter may be about 70%. The amount of data rate to be offloaded from the congested link to bring the utilization down to an acceptable threshold (e.g., about 70%) may be determined according to Equation (1) shown below.

DR_{MaxLinkOffload}=DR_{LinkCurrent}−(LinkCapacity*(TH_PR/100)) (1)

In Equation 1, DR_{MaxLinkOffload} is the data rate to be offloaded from the congested link, DR_{LinkCurrent} is the current data rate on the congested link, TH_PR is the threshold parameter as a percent, and LinkCapacity is the link capacity for the congested link.

At step S206, the network controller 1000 obtains information for incoming IP traffic flows on the congested link grouped by steering entity. As discussed above, the customer steering entity may be a destination Autonomous System (e.g., a customer network), destination subnetwork (e.g., network prefix), BGP Community group, or the like. For example purposes, this example embodiment will be described with regard to the customer steering entity being the destination customer network. As mentioned above, the network controller 1000 may obtain information regarding IP traffic flows through packet sampling protocols such as, for example, CFLOWD, NETFLOW, or the like.

In at least one example embodiment, the network controller 1000 may fetch or obtain aggregate data rates for the in-bound IP traffic flows on the congested link grouped by destination customer network (steering entity). The groups of in-bound IP traffic flows may be included in a list IP_FLOW_LIST and may be sorted in descending order according to the aggregate data rate for each group on the congested link. In one example, the aggregate data rates for the in-bound IP traffic flows may be obtained from a big data analytics system in the cloud 1100, placed in the list IP_FLOW_LIST, and the network controller 1000 may sort the groups of in-bound IP traffic flows in descending order based on the aggregate data rates for the groups of in-bound IP traffic flows.

Still referring to FIG. 2, at step S208, the network controller 1000 selects the group of IP traffic flows (grouped by steering entity) with the highest aggregate data rate from the list IP_FLOW_LIST (e.g., based on the obtained information). The network controller 1000 may also select the group of IP traffic flows having the highest aggregate data rate by selecting the steering entity associated with the group of IP traffic flows from the list IP_FLOW_LIST).

At step S209, the network controller 1000 determines whether there are any suitable alternate links available to offload the selected group of IP traffic flows. In one example, a suitable alternate link may be (or, alternatively, include) an E-BGP peering between a transit provider and a slice, which is connected to the destination customer network. The network controller 1000 may also take into account user's constraints such as selection boundary.

With regard to the network model shown in FIG. 1, in one example, if the destination customer network is customer network 1002, and the congested link is E-BGP peering CL-1 between transit provider 2001 and slice EAST, then suitable alternate links may be E-BGP peering link SAL-1 between the transit provider 2001 and slice CENTER and the E-BGP peering link SAL-2 between the transit provider 2002 and slice CENTER.

If the network controller 1000 determines that there are no suitable alternate links available at step S209, then the network controller 1000 determines whether there are remaining groups of IP traffic flows in the list IP_FLOW_LIST at step S218.

If there are no remaining groups of IP traffic flows in the list IP_FLOW_LIST, then the process terminates and the current link utilization remains.

Returning to step S218, if there are remaining groups of IP traffic flows in the list IP_FLOW_LIST, then at step S216 the network controller 1000 selects the group of IP traffic flows associated with the steering entity (customer network) with the next highest aggregate data rate from the list IP_FLOW_LIST (e.g., based on the obtained information).

The process then returns to step S209, and continues as discussed herein with regard to the next group of IP traffic flows selected at step S216.

If the network controller 1000 determines that there are suitable alternate links available for the selected group of IP traffic flows at step S209, then the network controller 1000 includes the suitable alternate links in the list LIST_ALT_LINK, orders the suitable alternate links in the list LIST_ALT_LINK in descending order according to at least the available bandwidth on the respective suitable alternate links, and determines whether a next alternate link with the highest available bandwidth in the list LIST_ALT_LINK is suitable for steering the selected group of IP traffic flows at step S210. In one example, the network controller 1000 determines whether the next alternate link in the list LIST_ALT_LINK is suitable for steering the selected group of IP traffic flows if the steering of the selected group of IP traffic flows from the congested link to the next alternate link does not increase the link utilization of the alternate link above a steering threshold (e.g., about 70% utilization).

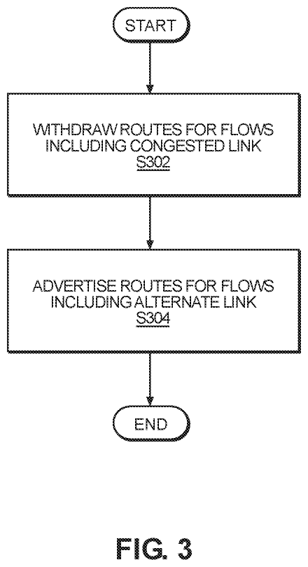

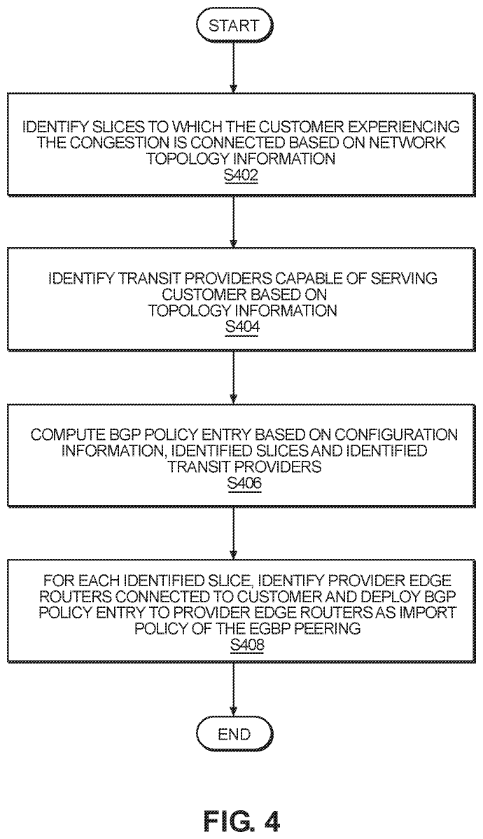

If the next alternate link with the highest available bandwidth in the list LIST_ALT_LINK is suitable for steering the selected group of IP traffic flows, then at step S212, the network controller 1000 steers the selected group of IP traffic flows to the suitable alternate link. In at least one example embodiment, the network controller 1000 may steer the selected group of IP traffic flows to the suitable alternate link by deploying BGP policy rules to, for example, the Autonomous System Border Router connecting the Autonomous System AS-1 to the transit provider or to the PE router (or routers) to which the customer network is connected. Methods for steering traffic according to example embodiments will be discussed in more detail later with regard to FIGS. 3 and 4.

At step S214, after offloading the selected group of IP traffic flows, the network controller 1000 determines whether the total (amount of) offloaded traffic from the congested link as a result of the steering is greater than or equal to the data rate to be offloaded determined at step S204. In one example, the network controller 1000 may wait for a given (or, alternatively, desired or predetermined) time period (e.g., about 1-3 minutes) for the BGP protocol to converge the routing changes, and then determine whether the total offloaded traffic from the congested link is greater than or equal to the data rate to be offloaded. The network controller 1000 may determine whether the total offloaded traffic from the congested link is greater than or equal to the data rate to be offloaded by obtaining link utilization in the same or substantially the same manner as discussed above with regard to step S202.

If the network controller 1000 determines that the total offloaded traffic from the congested link is greater than or equal to the data rate to be offloaded at step S214, then the process terminates.

Returning to step S214, if the network controller 1000 determines that the total offloaded traffic from the congested link is less than the data rate to be offloaded, then the process proceeds to step S216 and continues as discussed above.

Returning now to step S210, if the network controller 1000 determines that the next alternate link with the highest available bandwidth in the list LIST_ALT_LINK is not suitable for steering the selected group of IP traffic flows, then at step S211 the network controller 1000 determines whether there are remaining suitable alternate links in the list LIST_ALT_LINK that have not been checked to determine whether they are suitable for steering the selected group of IP traffic flows from the congested link.

If there are unchecked suitable alternate links in the list LIST_ALT_LINK, then the process returns to step S210 and continues as discussed above for the next alternate link in the list LIST_ALT_LINK.

Returning to step S211, if there are no additional unchecked alternate links in the list LIST_ALT_LINK, then the process proceeds to step S214 and continues as discussed herein.

When identifying and/or selecting a suitable alternate link, the network controller 1000 may consider link selection algorithm filters such as link colors, link selection boundaries, redundancy factors, or the like.

In one example, one or more E-BGP peering links may be colored to form a color group. If a link in the color group becomes congested, then the network controller 1000 may select the alternate link from the same color group.

Link selection boundaries define the boundary within which the network controller 1000 may select a suitable alternate link. In one example, the link selection boundary value may be ROUTER, SLICE, NETWORK, or the like. If the value is ROUTER, then the network controller 1000 may select the alternate link from among links including the same router as the congested link. If the value is SLICE, then the network controller 1000 may select the alternate link from among links in the same slice as the congested link. If the value is NETWORK, then the network controller 1000 may select the alternate link from anywhere in the network.

The redundancy factor ensures backup links for the steered traffic. For example, if the redundancy factor is three, then there exists a primary link and two back up links. If the redundancy factor is zero, then there is no redundancy. BGP polices deployed on the primary link advertise more favorable routes than the backup links using, for example, MED and AS_PATH BGP attributes. After identifying a suitable alternative link, other suitable alternative links in the list may be chosen as backups depending on the redundancy factor.

FIG. 3 is a flow chart illustrating a method according to another example embodiment. In more detail, FIG. 3 illustrates an example embodiment of a method for steering traffic flows (step S212 in FIG. 2) by deploying BGP policy rules to an Autonomous System Border Router.

Referring to FIG. 3, the network controller 1000 steers traffic from the congested link to the alternate link by withdrawing routes for flows traversing the congested link at step S302, and then advertising routes for the flows including the selected alternate link at step S304. According to at least some example embodiments, suitable alternate links identified as backup links may be advertised, but prepended to be less attractive, such that traffic flows on these backup links only if the main peer link goes down.

The network controller 1000 may perform each of steps S302 and S304 by deploying BGP policy entries in the export policy for the Autonomous System Boundary Routers for the E-BGP peering between the slices in the Autonomous System AS-1 and the transit providers 2001-2003.

In an alternative example, E-BGP peering links may be part of an Equal-Cost Multi-path (ECMP) group. In this example, if an E-BGP peering link in an ECMP group becomes congested, then the network controller 1000 computes the total incoming data rate for the group of IP traffic flows associated with a steering entity (e.g., destination customer network) for which the network controller 1000 is performing steering for all links in that group, and identifies an alternate link or another ECMP group that has enough remaining bandwidth to accommodate this total data rate (step S209 and S210 in FIG. 2). The network controller 1000 then deploys BGP policy entries to withdraw the route advertisements for the steering entity (e.g., destination customer network) on all links of the congested ECMP group, and advertises routes on the alternate link or all links of another ECMP group to steer the IP traffic flows (step S212 in FIG. 2) to the alternate link(s). In this example, ECMP groups may be treated as a single link bundle having asymmetric distribution of traffic across its link for a given steering entity.

FIG. 4 is a flow chart illustrating a method according to another example embodiment. In more detail, FIG. 4 illustrates an example embodiment of a method for steering traffic flows by deploying BGP policy rules or entries to a PE router.

The example embodiment shown in FIG. 4 will be discussed with regard to a pre-configured network with pre-defined BGP communities. In some cases, a pre-configured network with pre-defined BGP communities may be required to implement or deploy traffic steering on a PE router. In the example shown in FIG. 1, the PE routers PE-1, PE-2, PE-3 are ASBRs connecting a respective slice of the Autonomous System AS-1 with one or more destination customer networks.

With regard to the network model shown in FIG. 1, for example, when the PE router PE-1 tags a received BGP route (e.g., 1.2.3.X/32) with a predefined BGP community name (e.g., TRANSIT_2001_BLOCK) and advertises the BGP route to its I-BGP peers within the local network (e.g., within the Autonomous System AS-1), the advertisement reaches all border routers (e.g., Autonomous System Border Routers BR-1, BR-2, BR-3, routers ABR-1, ABR-2, ABR-3, PE routers PE-2, PE-3, etc.) in the local network. The tagging is a result of a modification of the import policy on the PE router PE-1. Border routers have preconfigured export policies on each E-BGP peering link to match with corresponding predefined communities of interest for that link. If the above community matches the export policy on a specific E-BGP peering in a border router, then the route (e.g., 1.2.3.X/32) is advertised with modified (e.g., MED or AS_PATH or both MED and AS_PATH) by that border router on its E-BGP peering link.

Customer BGP routes are received by PE routers on the local network through BGP peering links. The PE routers use their import policies on the E-BGP peering links to modify the received BGP routes and then advertise the modified routes to the border routers through I-BGP in the local network. The border routers then use export policies to further modify the routes, and propagate the modified routes to the transit providers.

For example purposes, a worked out example for steering downlink traffic by deploying BGP policy to a PE router is provided below with regard to the network model shown in FIG. 1. In this example, the steering entity is the destination customer network 1002, which has preconfigured export policies on the Autonomous System Border Routers in the Autonomous System AS-1, and the network controller 1000 steers the IP traffic flows by injecting import policy rules on the PE routers PE-1 and PE-2 to which the customer network 1002 is connected.

With regard to the network model shown in FIG. 1, the number of slices in the network is denoted by Z={EAST, CENTER, WEST}, the number of transit providers is denoted by T={TRANSIT 2001, TRANSIT 2002, TRANSIT 2003}, and the number of customer networks is denoted by C={CUSTOMER 1001, CUSTOMER 1002, CUSTOMER 1003, CUSTOMER 1004, CUSTOMER 1005}.

For every transit provider in the set “T”, “USE_COMMUNITY” and “BLOCK_COMMUNITY” are configured as BGP community names, which influence the AS_PATH attribute to enable selection of one transit provider over another. In one example, for “TRANSIT 2001” the BGP communities “TRANSIT_2001_USE” and “TRANSIT_2001_BLOCK” may be defined.

The export policy of the E-BGP peering between the border routers towards “TRANSIT 2001” in slices “EAST” and “CENTER” (border routers BR-1 and BR-2) are pre-configured to alter the AS_PATH attribute based on the above communities. For example, the export policy of the E-BGP peerings in Autonomous System Border Routers BR-1 and BR-2 will have a rule to identify traffic on I-BGP routes received with “TRANSIT_2001_BLOCK” community, and if so the action is to increase the AS_PATH length (e.g., significantly increase), and advertise these routes to “TRANSIT 2001” network peering routers making “TRANSIT 2001” least preferred transit provider for the customer network 1002.

On the other hand, the export policy of the E-BGP peerings in Autonomous System Border Routers BR-1 and BR-2 have another rule to identify traffic on I-BGP routes received with “TRANSIT_2001_USE” community, and if so the action is not to alter AS_PATH length, and advertise these routes to “TRANSIT 2001” network peering routers making “TRANSIT 2001” most preferred transit provider for the customer network 1002.

For each valid and connected transit provider “T” and slice “Z” direction combination, the “USE_COMMUNITY” and “BLOCK_COMMUNITY” BGP community names are configured to influence the MED attribute (e.g., selection of the direction for a preferred transit provider). For example, for the “TRANSIT 2001” and “EAST” combination, the BGP communities “TRANSIT_2001_EAST_USE” and “TRANSIT 2001 EAST BLOCK” may be defined. In this example, the export policy of the E-BGP peering between border router BR-1 towards “TRANSIT 2001” in slice “EAST” is will have rules to alter the MED attribute based on the above community matches. The “TRANSIT 2001 EAST BLOCK” will advertise a higher MED value (e.g., 500) so that the “EAST” direction is not preferred, whereas the “TRANSIT_2001_EAST_USE” will advertise a lower MED value (e.g., 100), making the “EAST” direction more preferred.

Given the foregoing configuration, a method for steering downlink traffic according to an example embodiment will now be described with regard to FIGS. 1 and 4 in a situation in which the network controller 1000 steers downlink IP traffic destined for a customer in customer network 1002 from the E-BGP peering link CL-1 between transit provider 2001 and slice EAST {“TRANSIT 2001” & “EAST”} (the congested link) to the E-BGP peering link SAL-2 between transit provider 2002 and slice CENTER {“TRANSIT 2002” & “CENTER”} (the alternate link).

Referring to FIG. 4, at step S402 the network controller 1000 determines the slices to which the customer in the customer network 1002 (the customer experiencing the congestion) is connected based on a network topology graph or map. In this example, since the customer belongs to the customer network 1002 (CUSTOMER 1002), the customer is connected to PE routers PE-1 and PE-2 in slices “EAST” and “CENTER”, and thus, the network controller 1000 determines that the customer is connected to slices “EAST” and “CENTER”.

At step S404, the network controller 1000 identifies the transit providers that may serve the customer experiencing the congestion based on the network topology graph. In this example, since the customer is connected to slices “EAST” and “CENTER”, the network controller 1000 determines that transit providers “TRANSIT 2001” and “TRANSIT 2002” may serve the customer experiencing the congestion.

At step S406, the network controller 1000 computes a BGP policy entry for the PE routers PE-1 and PE-2 based on the configuration information mentioned above, the slices identified at step S402 and the transit providers identified at step S404. In one example, the network controller 1000 generates the following BGP policy entry <XX> based on the configuration information and the information obtained in steps S402 and S404:

entry <XX> {

match {

autonomous-system “\hat{ }1002.*”

}
action {

community add (TRANSIT_2001_BLOCK,

```
  TRANSIT_2002_USE,
  TRANSIT_2002_EAST_BLOCK,
  TRANSIT_2002_CENTER_USE)
```

}

}

According to this BGP policy entry, for downlink traffic destined for the customer network 1002, the transit provider 2002 is preferred over the transit provider 2001, and the E-BGP peering link between the transit provider 2002 and the slice CENTER is preferred over the E-BGP peering link between the transit provider 2002 and the slice EAST.

At step S408, for each slice identified at step S402 (EAST and CENTER), the network controller 1000 identifies the one or more PE routers connected to the customer network 1002 and deploys the generated BGP policy entry to the identified PE routers as the import policy of the E-BGP peering with the customer network 1002. In the example discussed above, the network controller 1000 identifies the PE routers PE-1 and PE-2 as connected to the customer network 1002, and deploys the BGP policy entry <XX> to each of the PE routers as the import policy of the E-BGP peering with the customer network 1002. As discussed above, the PE routers PE-1 and PE-2 then use their import policies on the E-BGP peering links to modify the received BGP routes and then advertise the modified routes to the border routers BR-1 and BR-2 through I-BGP in the local network. The border routers BR-1 and BR-2 then use export policies to further modify the routes, and propagate the modified routes to the transit providers 2001 and 2002.

Although discussed herein with regard to E-BGP, example embodiments may also be applicable to I-BGP and I-BGP peering, wherein the relationship between routers is an I-BGP peering, rather than E-BGP peering.

Although discussed herein with regard to steering traffic by distribution of BGP policy, example embodiments may also be implemented by utilizing BGP route distribution to steer traffic.

According to at least some example embodiments, the network controller 1000 may determine whether to steer traffic based on BGP community bandwidth information.

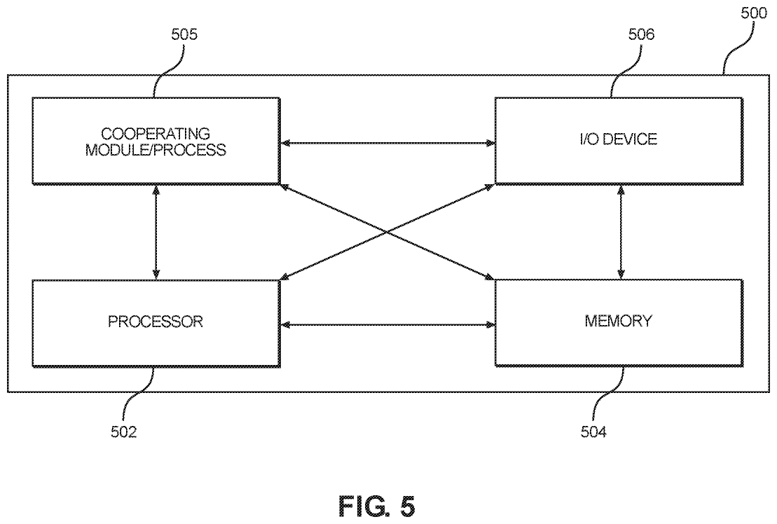

FIG. 5 depicts a high-level block diagram of a computer or computing device suitable for use in implementing, for example, the network controller 1000 shown in FIG. 1. Although not specifically described herein, the general architecture and functionality shown in FIG. 5 may also be suitable for implementing one or more other network elements discussed herein.

Referring to FIG. 5, the computer 500 includes one or more processors 502 (e.g., a central processing unit (CPU) or other suitable processor(s)) and a memory 504 (e.g., random access memory (RAM), read only memory (ROM), and the like). The computer 500 also may include a cooperating module/process 505. The cooperating process 1005 may be loaded into memory 504 and executed by the processor 502 to implement functions as discussed herein and, thus, cooperating process 505 (including associated data structures) may be stored on a computer readable storage medium (e.g., RAM memory, magnetic or optical drive or diskette, or the like).

The computer 500 also may include one or more input/output devices 506 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

Related art methods for controlling inbound traffic do not provide adequate insight into inbound traffic at the level of BGP usage and do not provide real-time network action when problems begin to occur on BGP peering links. One or more example embodiments employ a carrier SDN solution integrated with big data analytics providing policy and network control automation or semi-automation with real-time traffic monitoring and correlation for controlling inbound traffic. One or more example embodiments may integrate both routing programmability and control, routing-based traffic visibility, automatic congestion detection and reporting and finally peering topology map with traffic visibility. One or more of these elements integrated into a single application may provide service providers with a tool to proactively and real-time operate and understand inbound traffic destined or transiting their network, which may enable service providers to apply the correct policies at the appropriate time and at the appropriate network location.

One or more example embodiments may enable delivery of a more optimal user experience, improved security and/or visibility.

One or more example embodiments may provide increased productivity and user satisfaction by more efficiently and quickly responding to changes thereby minimizing delay and errors.

One or more example embodiments may reduce operational costs or impact of network congestion.

While one or more example embodiments are described from the perspective of the network controller, it will be understood that one or more example embodiments discussed herein may be performed by the one or more processors (or processing circuitry) at the applicable device. For example, according to one or more example embodiments, at least one memory may include or store computer program code, and the at least one memory and the computer program code may be configured to, with at least one processor, cause a network controller to perform the operations discussed herein.

It will be appreciated that a number of the embodiments may be used in combination.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing network elements, network controllers, clients, routers, gateways, nodes, computers, cloud-based servers, web servers, application servers, proxies or proxy servers, or the like. As discussed later, such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network resource controller to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, network elements, network controllers, clients, routers, gateways, nodes, computers, cloud-based servers, web servers, application servers, proxies or proxy servers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

The network elements, network controllers, clients, routers, gateways, nodes, computers, cloud-based servers, web servers, application servers, proxies or proxy servers, or the like, may also include various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more network elements, such as network controllers, clients, routers, gateways, nodes, computers, cloud-based servers, web servers, application servers, proxies or proxy servers, or the like.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1.-20. (canceled)

21. A network controller for steering traffic between peering links in a network, the network controller comprising:
at least one processor; and
at least one memory including computer program code, the at least one memory and the computer program code configured to, with the at least one processor, cause the network controller to
detect a congested peering link between a first router and a second router, the congested peering link carrying a plurality of traffic flows,
select a first group of traffic flows from among the plurality of traffic flows to be offloaded from the congested peering link, the first group of traffic flows being associated with a first steering entity indicative of destination information for the first group of traffic flows,
select an alternate peering link to which to offload the first group of traffic flows from the congested peering link, the alternate peering link being between the first router and the second router, and
steer the first group of traffic flows from the congested peering link to the alternate peering link.

22. The network controller of claim 21, wherein the first router is a border router in a first autonomous system and the second router is a neighbor router in a second autonomous system.

23. The network controller of claim 21, wherein the first router and the second router have a Border Gateway Protocol peering relationship.

24. The network controller of claim 23, wherein the Border Gateway Protocol peering relationship is an internal Border Gateway Protocol (I-BGP) peering relationship or an external Border Gateway Protocol (E-BGP) peering relationship.

25. The network controller of claim 23, wherein the at least one memory and the computer program code are further configured to, with the at least one processor, cause the network controller to steer the first group of traffic flows by updating at least one Border Gateway Protocol policy entry at one or more of the first router or the second router.

26. The network controller of claim 23, wherein the memory and the computer program code are further configured to, with the at least one processor, cause the network controller to steer the first group of traffic flows through Border Gateway Protocol route distribution.

27. The network controller of claim 23, wherein
the first router is a border router in a first autonomous system;
the first autonomous system is connected to a second autonomous system including at least one customer experiencing congestion resulting from the congested peering link; and
the at least one memory and the computer program code are further configured to, with the at least one processor, cause the network controller to steer the first group of traffic flows by
identifying, in the first autonomous system, at least one provider edge router connected to the customer experiencing the congestion, and
deploying at least one Border Gateway Protocol policy entry to the at least one provider edge router.

28. The network controller of claim 27, wherein the at least one memory and the computer program code are further configured to, with the at least one processor, cause the network controller to
identify slices within the first autonomous system configured to serve the customer experiencing the congestion based on topology information for the network;
identify transit providers configured to serve the customer experiencing the congestion based on the topology information for the network; and
generate the at least one Border Gateway Protocol policy entry based on the slices, the transit providers and network configuration information for the network.

29. The network controller of claim 21, wherein the memory and the computer program code are further configured to, with the at least one processor, cause the network controller to detect the congested peering link based on a real-time link utilization threshold and a real-time link utilization for the congested peering link.

30. The network controller of claim 21, wherein the at least one memory and the computer program code are further configured to, with the at least one processor, cause the network controller to steer the first group of traffic flows by
withdrawing routes for traffic flows including the congested peering link, and
advertising routes for traffic flows including the alternate peering link.

31. The network controller of claim 21, wherein the first steering entity includes (i) a destination autonomous system for the first group of traffic flows, (ii) a destination subnetwork for the first group of traffic flows, or (iii) a Border Gateway Protocol Community group for the first group of traffic flows.

32. The network controller of claim 21, wherein
the plurality of traffic flows include a plurality of groups of traffic flows, each of the plurality of groups of traffic flows being associated with a steering entity;
the at least one memory and the computer program code are further configured to, with the at least one processor, cause the network controller to
obtain aggregate data rates for each of the plurality of groups of traffic flows,
sort the plurality of groups of traffic flows in descending order based on the aggregate data rates for the plurality of groups of traffic flows, and
select a group of traffic flows having a highest aggregate data rate as the first group of traffic flows.

33. The network controller of claim 21, wherein the at least one memory and the computer program code are further configured to, with the at least one processor, cause the network controller to
determine that a total amount of traffic offloaded from the congested peering link by steering the first group of traffic flows from the congested peering link to the alternate peering link is less than a threshold data rate to be offloaded from the congested peering link,
select a second group of traffic flows from among the plurality of traffic flows to be offloaded from the congested peering link, the second group of traffic flows being associated with a second steering entity indicative of destination information for the second group of traffic flows,
select a second alternate peering link to which to offload the second group of traffic flows from the congested peering link, the second alternate peering link being between the first router and the second router, and
steer the second group of traffic flows from the congested peering link to the second alternate peering link.

34. A method for steering traffic between peering links in a network, the method comprising:
detecting a congested peering link between a first router and a second router, the congested peering link carrying a plurality of traffic flows;
selecting a first group of traffic flows from among the plurality of traffic flows to be offloaded from the congested peering link, the first group of traffic flows being associated with a first steering entity indicative of destination information for the first group of traffic flows;
selecting an alternate peering link to which to offload the first group of traffic flows from the congested peering link, the alternate peering link being between the first router and the second router; and
steering the first group of traffic flows from the congested peering link to the alternate peering link.

35. The method of claim 34, wherein the first router and the second router have a Border Gateway Protocol peering relationship.

36. The method of claim 35, wherein the Border Gateway Protocol peering relationship is an internal Border Gateway Protocol (I-BGP) peering relationship or an external Border Gateway Protocol (E-BGP) peering relationship.

37. The method of claim 34, wherein the first router is a border router in a first autonomous system and the second router is a neighbor router in a second autonomous system.

38. The method of claim 34, wherein the detecting detects the congested peering link based on a real-time link utilization threshold and a real-time link utilization for the congested peering link.

39. A non-transitory computer-readable medium including computer-readable instructions that, when executed, cause at least one processor at a network controller to cause the network controller to perform a method comprising:
detecting a congested peering link between a first router and a second router, the congested peering link carrying a plurality of traffic flows;
selecting a first group of traffic flows from among the plurality of traffic flows to be offloaded from the congested peering link, the first group of traffic flows being associated with a first steering entity indicative of destination information for the first group of traffic flows;
selecting an alternate peering link to which to offload the first group of traffic flows from the congested peering link, the alternate peering link being between the first router and the second router; and
steering the first group of traffic flows from the congested peering link to the alternate peering link.

40. The non-transitory computer-readable medium of claim 39, wherein the first router and the second router have a Border Gateway Protocol peering relationship.
